(19) United States
(12) Patent Application Publication
(10) Pub. No.: US 2017/0214479 A1
(43) Pub. Date: Jul. 27, 2017

(54) METHOD FOR TRANSMITTING TIME SYNCHRONIZATION MESSAGES IN A COMMUNICATION NETWORK, NETWORK COMPONENT, AND COMMUNICATION NETWORK

(71) Applicant: SIEMENS AKTIENGESELLSCHAFT, MUNICH (DE)

(72) Inventor: HOLGER HEINE, AURICH (DE)

(21) Appl. No.: 15/500,625

(22) PCT Filed: Jul. 31, 2014
(86) PCT No.: PCT/EP2014/066495

§ 371 Date: Jan. 31, 2017

(51) Int. Cl. H04J 3/06; H04W 56/00; H04B 7/26; H04L 7/04; H04N 21/43

(52) U.S. Cl. CPC H04J 3/0635; H04L 7/04; H04J 3/0685; H04N 21/4305; H04J 3/0652; H04B 7/269; H04W 56/00

(57) ABSTRACT

A method for transmitting time synchronization messages in a communication network between a master clock and a slave clock to be synchronized with the time of the master clock. A network component of the communication network receives the time synchronization messages on one port and sends the time synchronization messages on another port. The network component determines a dwell time of a respective time synchronization message between the receipt and the sending with an internal clock and transmits dwell-time information to the slave clock. The slave clock synchronizes to the master clock using the received time synchronization messages and the associated dwell-time information. In order to perform accurate determination of the dwell-time information in a network component with an internal clock having comparatively low accuracy, the network component suspends all other messages within a time period in which the network component expects to receive a time synchronization message.

The invention relates to a method for transmitting time synchronization messages in a communication network, in which time synchronization messages are transmitted via the communication network between a master clock and a slave clock to be synchronized with the clock time of the master clock, a network component of the communication network, which has at least two ports, receives the time synchronization messages at one port and dispatches them via another port, the network component determines, by means of an internal clock, a dwell time of a respective time synchronization message within the network component between receiving and dispatching the time synchronization message and conveys dwell time information specifying the dwell time to the slave clock, and the slave clock performs a synchronization to the master clock by using the respective received time synchronization messages and the respective associated dwell time information.

The invention also relates to a correspondingly configured network component and a correspondingly designed communication network.

In communication networks, the requirement frequently exists to synchronize devices connected to the communication network with one another in time. For this purpose, the individual devices usually contain their own clocks which must be synchronized to one another by means of special methods. An accurate time synchronization is of particular importance in automation and control systems for technical systems and processes which have spatially distributed automation devices which are connected to one another via a communication network.

Requirements which presuppose a temporal synchronization in this case exist, for example, in being able to detect measurement values synchronously in time with a number of automation devices or being able to compare measurement values of a number of automation devices with one another on the basis of time stamps. In addition, monitoring, control and regulating tasks must be performed frequently synchronized exactly with one another in time. In such automation and control systems, the clocks of different automation devices usually must be synchronized to one another within a microsecond range. One example of an automation system is a power automation system for controlling and monitoring and for protecting electrical power supply systems and switching stations (“substation automation system”).

One possibility for synchronizing clocks of distributed devices consists in receiving in each device a time clock distributed by means of a radio transmitter and adapting the respective device-internal clock to the time clock. For example, the time signal sent out by the satellite-based GPS system (GPS=Global Positioning System) can be used for this purpose. This solution is comparatively expensive due to the receivers in all devices to be synchronized, which are necessary for this purpose; in addition, adequate reception of the GPS time signal is not ensured everywhere.

Another possibility consists in using the communication network itself for time synchronization. In this case, time synchronization messages are transmitted within the communication network and used for time synchronization. One method for performing a time synchronization by means of time synchronization messages is specified, for example, in the international standard IEEE 1588-2008 and is called “Precision Time Protocol” (PTP).

According to the PTP standard, a connected device is selected within a communication network by means of a so-called “Best Master Clock” algorithm as so-called “grandmaster clock” to the clock of which all other devices (slave clocks, also called “ordinary clocks”) are to be synchronized. For this purpose, the grandmaster sends time synchronization messages at a sending time t₁ of its own clock to the slaves. This time t₁ is entered either directly in the time synchronization message or conveyed to the slaves in a follow-up message. The respective slave receives the time synchronization message and performs with known time delay (offset) between the sending time t₁ of the time synchronization message at the grandmaster and the associated receive time t₂ according to the clock of the slave a corresponding adaptation of its clock time for time synchronization.

The offset between the dispatch time t₁ and the receive time t₂ is given by the transmission time between the grandmaster and the slave and is determined at regular intervals in accordance with the method described subsequently. For this purpose, the grandmaster sends a time synchronization message at the sending time t₁ of its own clock to the respective slave. The slave stores its input time t₂ in accordance with its own clock. Following this, the slave sends a further time synchronization message (delay_request) to the grandmaster and stores its sending time t₃. The grandmaster receives the time synchronization message from the slave and stores its receive time t₄. This time t₄ is thereupon conveyed to the slave with a response (delay_response) in which the times t₁ to t₄ are now present. From these, the slave, using the equation,

$$OS = \frac{( {t}_{2} - {t}_{1} ) - ( {t}_{4} - {t}_{3} )}{2}$$

can calculate the difference OS (offset) between its clock and the grandmaster clock and use it for tracking its own clock. To apply this equation, it is assumed that dispatching the messages from the grandmaster to the slave takes the same time as dispatching messages in the opposite direction from slave to grandmaster.

In order to be able to perform a time synchronization also in more complex communication networks, so-called boundary clocks have been defined according to IEEE 1588, apart from the grandmaster clock and the slave clocks, which boundary clocks can both assume, in interaction with the grandmaster, a slave role and perform, in interaction with other slave clocks, a master role. In principle, a master clock performs the same steps with the connected slaves as described above for the grandmaster/slave relationship, only the master clocks also have to synchronize themselves as slaves with the grandmaster clock. In the text which follows, both the grandmaster clock and master clocks subordinate to the grandmaster clock are called master clocks in summary, unless mentioned otherwise.

Apart from the boundary clocks, the definition for so-called transparent clocks also exists since version 2 of IEEE 1588 standard from the year 2008, which only forward the time synchronization messages between a master clock and a slave clock without independently handling the roles of, on the one hand, a slave clock and, on the other hand, a master clock. Such transparent clocks can be, for example, network components in the form of switches or routers. Since, however, the period of time during which a time synchronization message dwells within such a network component before being forwarded depends on various factors, and is usually not constant, such network components must determine the dwell time with their own internal clock and convey it as dwell time information to the slave clock, so that the dwell time information from the slave jointly with the known offset for the time synchronization with the master clock can be taken into consideration.

A method of the type initially mentioned, in which a is network component which represents a transparent clock is used, is known, for example, from EP 2680466 A1. The known method has the aim of using a particular section of the time synchronization message, e.g. a preamble, for conveying the dwell time information. In this context, EP 2680466 A1 also describes that by means of the internal clock of the network component, receive and dispatch times of the respective time synchronization messages are measured.

In order to be able to determine the dwell time within the network component, however, a highly accurate clock is usually used since the accuracy of a time synchronization of the connected slaves greatly depends on the accuracy of the dwell time determined, particularly in the case of a number of network components arranged following one another as a cascade which represent transparent clocks. This highly accurate clock must itself be synchronized in time in order to avoid drifting between the grandmaster clock or the master clocks, respectively, and the internal clock of the network component. Due to the high requirements, the internal clocks to be used in such network components are usually comparatively expensive.

Starting from a method of the type initially specified, the invention is based on the object of being able to perform a determination of the dwell time information, which is as accurate as possible, in a network component even when using an internal clock having a comparatively low accuracy.

This object is achieved by a method of the type initially mentioned in which the network component stops dispatching other messages which are not time synchronization messages within a period in which it expects a reception of a time synchronization message.

The invention is based on the finding that the essential and most variable component of the dwell time of a time synchronization message within the network component arises due to the impending dispatching of other messages which are also transmitted via the communication network. Other messages which are transmitted via the same communication network as the time synchronization messages can contain, among other things, for example, measurement values, control commands, status messages, recorded measurement value sequences, software updates etc.

Thus, for example, good Ethernet switches in automation systems in the no-load state (no other messages to be transmitted) can limit the dwell time of a time synchronization message to about 5 μs. In the loaded state (other messages are also transmitted at the same time) of such a switch, in contrast, the dwell time rises slightly up to 125 μs. If an internal clock with an inaccuracy of 50 ppm is used, an inaccuracy of 0.25 ns results from the measurement of the dwell time in the no-load case. In the loaded case, the inaccuracy of the measurement of the dwell time, in contrast, rises to 6.25 ns. In the case of a number of series-connected network components (for example in annular communication networks), this inaccuracy rapidly adds up to unacceptable errors in the time synchronization. In usual communication networks of automation systems, the number of series-connected network components between master and slave can easily assume a value of approx. 50.

At this point, the invention comes into action. Namely, instead of increasing the accuracy of the internal clock of a network component by using expensive components (which, for example, would presuppose the use of an internal clock of the network components having an accuracy of 0.5-1 ppm), care is taken instead, according to the invention, that the dwell time of the time synchronization message within the network component is as short as possible. Since the inaccuracy of the dwell time determined is, in principle, the result of being a product of the inaccuracy of the internal clock of the network component and of the dwell time itself, a reduction of the inaccuracy during the determination of the dwell time can also be achieved in this way—and without using expensive components. By this means, it is possible to use, for example, more cost-effective internal clocks having accuracies of 50 ppm or worse.

Said briefly, the dispatching of the time synchronization message is prepared proactively by the network component by the method according to the invention. Since this only requires the dispatching of other messages to be stopped from time to time, no elaborate measures with regard to control software of the network component need to be implemented, either. A delaying effect on the other messages to be transmitted by the network component can also be kept very small with a time domain selected to be sufficiently small and due to the shortness of the time synchronization messages themselves.

According to an advantageous embodiment of the method according to the invention, it is provided that dispatching of the other messages is continued if the time synchronization message expected in the period has been received and dispatched.

In this way, the interruption of the dispatching of the other messages can be kept as short as possible. This is because the end of the period in which the time synchronization message is expected is not absolutely mandatorily waited for. This is because dispatching the other messages is resumed immediately as soon as the expected time synchronization message has been dispatched, even if the time of dispatching should lie before the end of the time domain in question.

A further advantageous embodiment of the method according to the invention provides that, for stopping the dispatching of the other messages, the network component interrupts the processing of a message queue in which the other messages are temporarily stored before their dispatch.

By this means, the dispatch memory into which the time synchronization message is shifted immediately before being dispatched is proactively kept free for the time synchronization message since from time to time no other messages from the queue are displaced any longer for messages to be dispatched here.

A further advantageous embodiment of the method according to the invention also provides that the period in which the reception of a time synchronization message is expected is predetermined by the fact that the time synchronization messages are dispatched at regular intervals by the master clock and/or the slave clock.

This is because frequently the time synchronization messages are dispatched regularly at constant time intervals by the master. For example, a time synchronization message can be dispatched once per second. The network component, when knowing the dispatch timing, can therefore derive the expected time of the reception of the next time synchronization message from the last time synchronization message received. Even if the dispatch timing should not be previously known, the network component can derive from the times of two or more time synchronization messages already received, apart from the expected time for receiving the next time synchronization message, also the dispatch timing. Correspondingly, time synchronization messages which are dispatched by the slave clock to the master clock can also be sent out at regular intervals. The beginning of the period can be set in this case, for example, to the dispatch time, known in the slaves, of the time synchronization message at the master.

As an alternative to the embodiment mentioned last, it can also be provided, however, that the master clock and/or the slave clock dispatches, before dispatching a time synchronization message, an announcement message which announces the subsequent dispatching of the time synchronization message, and the network component uses the announcement message for determining the period in which it expects a reception of a time synchronization message.

By this means, the period for the expected reception of the time synchronization message by the network component can be specified especially with irregular dispatch of time synchronization messages. It is alternatively possible to agree in this context that the time synchronization message is sent out after a fixed time interval has elapsed after the announcement message so that the network component can derive the period directly from the receive time of the announcement message. As an alternative, the announcement message can contain either the time interval lying between the announcement message and time synchronization message or the planned dispatch time of the time synchronization message.

A further advantageous embodiment of the method according to the invention provides that the network component enters the dwell time information directly into the associated time synchronization message and dispatches the time synchronization message, modified in this manner, instead of the time synchronization message originally received.

This can take place, in particular, in the case of a fast hardware-supported determination of the dwell time information.

As an alternative, it can also be provided that the network component enters the dwell time information into a follow-up message and dispatches the follow-up message after the associated time synchronization message.

This variant offers itself particularly with a slower software-supported determination of the dwell time information.

The above-mentioned object is also achieved by a network component for operation in a communication network for transmitting time synchronization messages between a master clock and a slave clock to be synchronized with the clock time of the master clock, wherein the network component has at least two ports and is configured to receive the time synchronization messages at one port and to dispatch them via another port, and wherein the network component is configured to determine, by means of an internal clock, a dwell time of a respective time synchronization message within the network component between receiving and dispatching the time synchronization message and to convey dwell time information specifying the time to the slave clock.

According to the invention, it is provided that the network component is configured to stop the dispatching of other messages which are not time synchronization messages within a period in which it expects a reception of a time synchronization message.

In addition, the above-mentioned object is also achieved by a communication network for transmitting time synchronization messages between a master clock and a slave clock to be synchronized with the clock time of the master clock, wherein the communication network has a network component which has at least two ports and is configured to receive the time synchronization messages at one port and to dispatch them via another port, wherein the network component is also configured to determine, by means of an internal clock, a dwell time of a respective time synchronization message within the network component between receiving and dispatching the time synchronization message and to convey dwell time information specifying the dwell time to the slave clock, and wherein the slave clock is configured to perform a synchronization to the master clock by using the respective received time synchronization messages and the respective associated dwell time information.

According to the invention, it is provided that the network component is configured to stop the dispatching of other messages which are not time synchronization messages within a period in which it expects a reception of a time synchronization message.

With regard to the network component according to the invention and the communication network according to the invention, all statements made precedingly and subsequently with respect to the method according to the invention and inversely apply correspondingly; in particular, the network component according to the invention and the communication network according to the invention are configured for performing the method according to the invention in any arbitrary embodiment or a combination of arbitrary embodiments. With regard to the advantages of the network component according to the invention and of the communication network according to the invention too, reference is made to the advantages described with respect to the method according to the invention.

The invention will be explained in greater detail in the text which follows by means of an exemplary embodiment. The specific design of the exemplary embodiment is to be understood to be in no way restrictive in respect of the general design of the method according to the invention, of the network component according to the invention and of the communication network according to the invention; instead, individual design features of the exemplary embodiment can be arbitrarily freely combined with one another and with the features described previously.

In the figures:

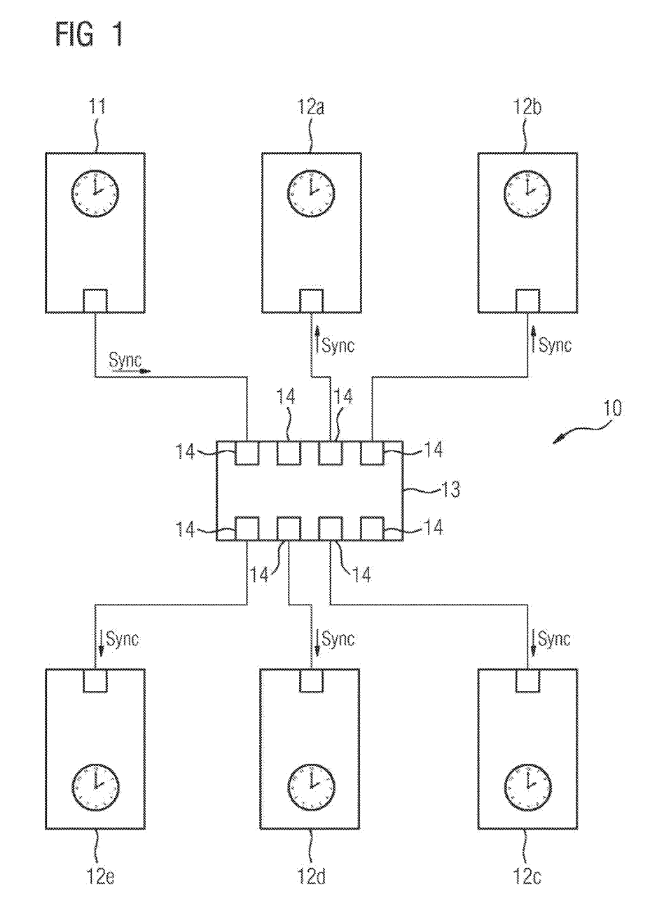

FIG. 1 shows a first exemplary embodiment of a communication network comprising a master clock and a number of slave clocks to be synchronized with the master clock;

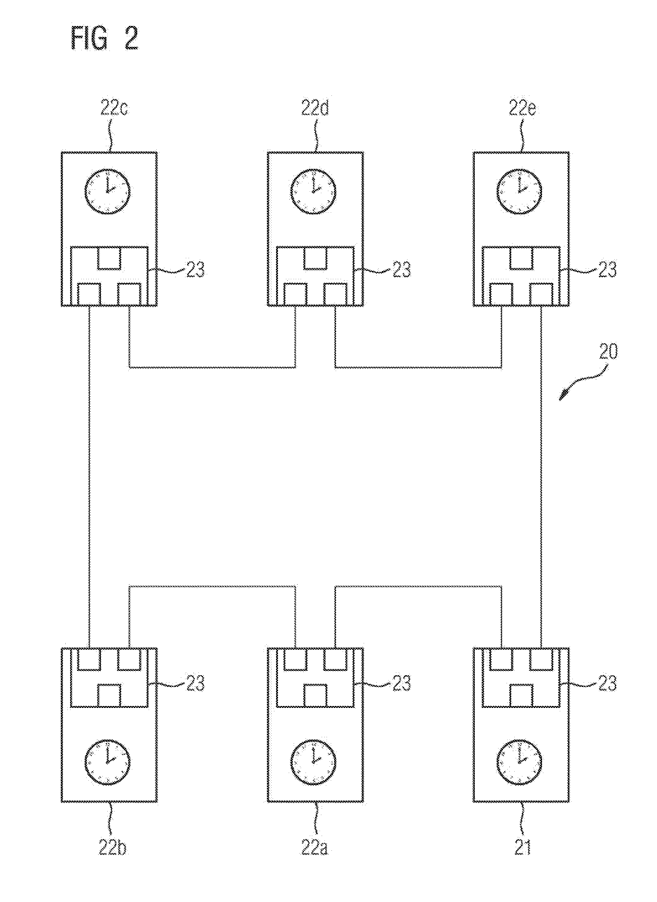

FIG. 2 shows a second exemplary embodiment of a communication network comprising a master clock and a number of slave clocks to be synchronized with the master clock; and

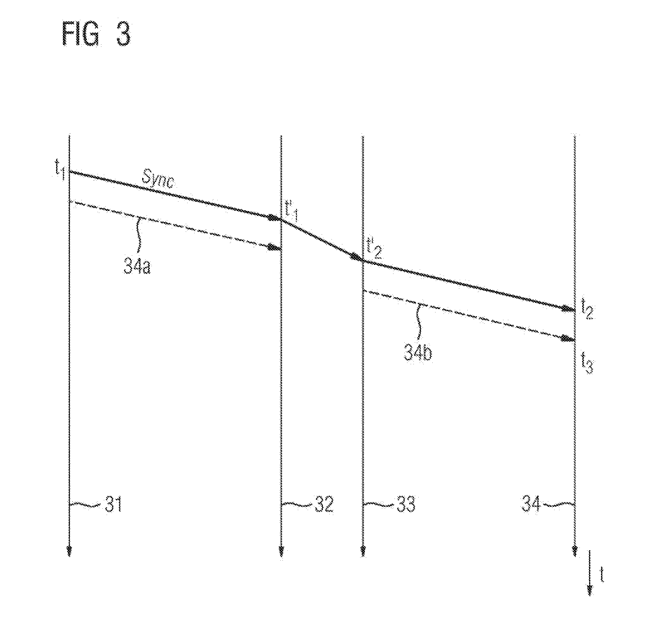

FIG. 3 shows a diagrammatic flow chart for explaining the transmission of time synchronization messages via a network component.

FIG. 1 shows in a diagrammatic view a communication network 10 to which network-capable devices in the form of a master clock 11 and a number of slave clocks 12a-e are connected. The devices can be, in particular, automation devices of an automation system, e.g. for the automation of an electrical power supply system. This can be, for example, protective devices, measuring devices, phasor measuring devices, power meters, power quality devices, management and control devices, switch controllers etc. of an electrical power automation system. Generally, such automation devices can also be called field devices or intelligent electronic devices (LEDs). However, since the time synchronization functionality is in the foreground at this point, the devices are subsequently called master or slave clocks, respectively, from this point of view. As already mentioned previously, the term master clock also comprises the selected grandmaster clock to which lastly all devices are synchronized in the communication network.

In addition, the communication network 10 comprises a network component 13 which can be, for example, a switch, a bridge or a router having a number of ports 14.

The network component 13 represents a “transparent clock” in the sense of the IEEE 1588-2008 standard.

Deviating from the simplified representation according to FIG. 1, the communication network can also comprise a number of series-connected network components which represent such transparent clocks.

In the communication network 10, messages are exchanged which can contain, for example, measurement values, control commands, status messages, recorded measurement value sequences or software updates. Summarized, such messages are called “other messages”. In order to also perform a synchronization of the slave clocks 12a-e with regard to the master clock 11, time synchronization messages are additionally also exchanged in the communication network 10. This will be described more accurately later.

In FIG. 2, a further exemplary embodiment of a communication network 20 is shown, the communication network 20 having an annular topology in comparison with the communication network 10 of FIG. 1. FIG. 2 shows in a diagrammatic view a communication network 20 to which network-capable devices in the form of a master clock 21 and a number of slave clocks 22a-e are connected.

The master clock 21 and the slave clocks 22a-e comprise integrated network components 23 which can be, for example, integrated 3-port switches. The network components 23 also represent transparent clocks in the sense of the IEEE 1588-2008 standard since, for example, the synchronization of the slave clock 22b with the master clock 21 takes place via the network component 23 of the slave clock 22a as transparent clock.

In the communication network 20, time synchronization messages are exchanged for synchronization of the slave clocks 22a-e with regard to the master clock 21.

In addition, other messages are also exchanged.

In the text which follows, a method for time synchronization by means of time synchronization messages which are transmitted in the communication network 10 will be described by way of example by means of FIGS. 1 and 3.

The method described in the text which follows can be correspondingly transferred also to the communication network 20 or to other communication networks in which time synchronization is performed. For this purpose, a flow chart is additionally specified in FIG. 3 in which the transmission of a time synchronization message is entered along time rays. In this context, time ray 31 represents the events at the master clock 11, time ray 32 represents the events at a slave clock 12a-e (for the subsequent statements, slave clock 12a will be selected as example for the sake of simplicity) and time rays 33a and 33b represent the events at a first and a second port of the network component 13.

At a time t=t₁, the master clock 11 sends a time synchronization message “sync” as broadcast message to the slave clocks 12a-e, among these also to the slave clock 12a. The dispatch time t₁ is added to the time synchronization message “sync” as information. Alternatively to the direct attachment of the dispatch time, the latter could also be transmitted by means of a subsequent follow-up message—indicated by a dashed arrow 34a.

The time synchronization message “sync” is received at the first port of the network component 13 at time t=t₁′, processed internally and dispatched at the second port of the network component 13 in the direction of the slave clock 12a at time t=t₁″. The network component 13 then acquires the dwell time t₁″−t₁′ and enters it directly into the forwarded time synchronization message “sync” as dwell time information. Alternatively, the dwell time information—as indicated by a dashed arrow 34b in

FIG. 3—could also be entered by the network component 13 in a follow-up message and dispatched in the direction of the slave clock 12a.

The slave clock 12a receives the time synchronization message “sync” (and any follow-up messages 34a, 34b), acquires the receive time t=t₂ and thus has the information about times t₁ and t₂ and about the dwell time information t₁″−t₁′. In the case of a known offset OS and correctly synchronized clocks, the relation

t₂−(OS+(t₁″−t₁′))=t₁

must be fulfilled. Otherwise, the slave clock must be correspondingly corrected for time synchronization. The offset OS can be determined once or regularly according to the method explained further above.

To be able to determine the dwell time information within the network component 13, the network component has an internal clock which measures the receive time and the dispatch time of the time synchronization messages. In this context, the dwell time must be determined as accurately as possible since it is included directly in the time synchronization of the slave clocks. In particular, in a communication network with a number of series-connected network components (for example an annular communication network as specified in FIG. 2), inaccuracies namely become added together in the determination of the dwell time and thus falsify the result of the time synchronization.

So that, in order to reduce the inaccuracy in the determination of the dwell time, it is not necessary to access especially accurate and thus expensive internal clocks for the network components, the dwell time itself is influenced in such a manner that it is as short as possible. For this purpose, it is provided that the network component 13 stops the dispatch of other messages within a period at which it expects the reception of a time synchronization message from the master clock. In this way, the main cause of a long dwell time, namely the blocking of the dispatch of a time synchronization message by another message currently still to be dispatched, can be eliminated. For example, the network component interrupts the processing of a queue with other messages to be dispatched temporarily during the period in question so that the time synchronization message, when it arrives, can be forwarded directly, i.e. without having to wait for the dispatch of another message. This reduces the dwell time of the time synchronization message to an absolute minimum, as a result of which only little inaccuracies occur in the determination of the dwell time which is already short per se, even when utilizing an internal clock having comparatively little accuracy.

After conclusion of the dispatching of the time synchronization message, it is possible to continue the dispatching of the other messages directly.

The period in question, at which the reception of a time synchronization message is expected, can be derived, for example, from the time of reception of the respective last time synchronization messages in the case of a regular dispatch of the time synchronization messages by the master clock and/or the slave clocks. Alternatively, the master clock or the slave clocks, respectively, can also dispatch announcement messages which announce a speedy transmission of the next time synchronization message in each case.

1-9. (canceled)

10. A method for transmitting time synchronization messages in a communication network, the method comprising:
transmitting time synchronization messages via the communication network between a master clock and a slave clock to be synchronized with a clock time of the master clock;
receiving, with a network component of the communication network having at least two ports, the time synchronization messages at one port and dispatching the time synchronization messages via another port;
determining by way of an internal clock of the network component, a dwell time of a respective time synchronization message within the network component between receiving and dispatching the time synchronization message and conveying the dwell time information specifying the dwell time to the slave clock;
synchronizing the slave clock to the master clock by using the time synchronization messages and the respectively associated dwell time information; and
during a time period in which the network component expects to receive a time synchronization message, suspending a dispatch by the network component of all other messages that are not time synchronization messages.

11. The method according to claim 10, which comprises continuing to dispatch the other messages after the time synchronization message expected in the period has been received and dispatched.

12. The method according to claim 10, wherein the suspending step comprises interrupting, with the network component, processing of a message queue in which the other messages are temporarily stored before dispatch.

13. The method according to claim 10, wherein the period in which the reception of a time synchronization message is expected is predetermined by the fact that the time synchronization messages are dispatched at regular intervals by the master clock and/or the slave clock.

14. The method according to claim 10, which comprises:
before dispatching a time synchronization message, dispatching from the master clock and/or the slave clock an announcement message which announces a subsequent dispatching of the time synchronization message; and
using the announcement message by the network component for determining the period in which to expect a reception of a time synchronization message.

15. The method according to claim 10, wherein the network component enters the dwell time information directly into the associated time synchronization message and dispatches the time synchronization message, modified with the dwell time information, instead of the time synchronization message originally received.

16. The method according to claim 10, wherein the network component enters the dwell time information into a follow-up message and dispatches the follow-up message after the associated time synchronization message.

17. A network component for operation in a communication network for transmitting time synchronization messages between a master clock and a slave clock to be synchronized with the clock time of the master clock, the network component comprising:
at least two ports, including a first port configured to receive the time synchronization messages and a second port configured to dispatch the time synchronization messages;
the network component being configured to determine, by way of an internal clock, a dwell time of a respective time synchronization message within the network component between receiving and dispatching the time synchronization message and to convey dwell time information specifying the dwell time to the slave clock; and
the network component being configured to stop dispatching other messages which are not time synchronization messages within a period in which a reception of a time synchronization message is expected.

18. A communication network for transmitting time synchronization messages between a master clock and a slave clock to be synchronized with a clock time of the master clock, the communication network comprising:
a network component with at least two ports, including a port for receiving the time synchronization messages and another port for dispatching the time synchronization messages;
said network component being configured to determine, by way of an internal clock, a dwell time of a respective time synchronization message within said network component between receiving and dispatching the time synchronization message and to convey dwell time information specifying the dwell time to the slave clock;
the slave clock being configured to perform a synchronization to the master clock by using the respectively received time synchronization messages and the respectively associated dwell time information; and
said network component being configured to suspend dispatching other messages that are not time synchronization messages within a period in which a reception of a time synchronization message is expected.
